(19) United States
(12) Patent Application Publication
(10) Pub. No.: US 2006/0003749 A1
(43) Pub. Date: Jan. 5, 2006

(54) System and method for constructing, distributing and applying at least one network use offer to at least one mobile terminal

(76) Inventor: Christian Faisy, Saint Denis De La Reunion (FR)

Correspondence Address: PERMAN & GREEN, 425 POST ROAD, FAIRFIELD, CT, 06824, US

(21) Appl. No.: 11/157,130

(22) Filed: Jun. 20, 2005

(30) Foreign Application Priority Data
Jul. 2, 2004 (FR) 04 0 07 329

(51) Int. Cl. H04Q 7/20

(52) U.S. Cl. 455/414.1; 455/422.1

(57) ABSTRACT

The present invention concerns a system for constructing, distributing and applying at least one promotional offer, including at least one transmission station (2) to which is connected at least one mobile terminal (1), an interactive vocal service (10), several databases (11, 8a, 8b, 6) containing information on clientele or network status, characterized in that an application sub-system (5) polls the transmission stations (2) forming a mobile telephony network (4) to know its load rate and the SIM card IMSI numbers of mobile terminals (1) connected to the network, these results are stored in a support database (6) and interpreted in the light of data contained in the other databases (11, 8a, 8b) by the application system (7) which invites the selected mobile terminal users to contact the interactive vocal service (10) to have a promotional offer.

The present invention relates to a system and method for constructing, distributing and applying at least one offer for network use to at least one terminal connected to a communication network, preferably a mobile telephony network.

Telephony networks require major investments and are designed in relation to traffic forecasts. To meet this forecasted traffic as closely as possible operators have determined price offers which take into account time slots when traffic is lower. These solutions are based on the use of a table of predetermined price rates which do not enable fine-tuned management of parameters such as network load by offering price rates which vary in relation to its availability. With these solutions it is not possible either to manage price offers adaptable in relation to the analysis of determinant criteria concerning users already on the network.

The purpose of the present invention is to eliminate some disadvantages of the prior art by proposing a system for constructing, distributing and applying a network use offer that is limited and scalable in time and which uses full load parameters for a network, preferably a mobile telephony network, and the network attachment profile of customers to be targeted. With the system of the invention a table of predetermined price rates can be substituted by a management system for promotional price rates that are time-adjustable and offered to previously targeted customers.

This purpose is achieved through a system for constructing, distributing and applying at least one promotional offer for use of a network, in particular a mobile telephony network, comprising at least one transmission station connected to at least one mobile terminal, an interactive vocal service, and several databases containing data on customers or data on network status, characterized in that an application sub-system activated via the input interface of an application system polls the transmission stations forming a mobile telephony network to determine the activity rate of the network and determine the SIM card IMSI number of the mobile terminals connected to the network, these results being stored in a support database and compared with data contained respectively in the support, marketing and offer databases by the application system which, in relation to criteria, determines selected users and sends a message to selected mobile terminal users inviting them to contact the interactive vocal system to have a personalised promotional price offer.

According to another characteristic, the application sub-system polls the transmission stations via the remote polling channels of the network's physical layers or by probes.

According to another characteristic, the polling of the transmission stations enables determination of their immediate load rate and hosting rate.

According to another characteristic, the parameters concerning the transmission stations and contained in the application system represent the stations load rate, the exclusion of some of them from the promotional offer, the <<handover>> rate and the <<roaming>> rate.

According to another characteristic, the invitation given to the user to contact the interactive vocal service is made by SMS or WAP push.

According to another characteristic, the support data base contains information derived from network polling made by the application sub-system and the SIM card IMSI number of terminals connected to the network at the time of polling.

According to another characteristic, an offer database contains data on the different types of existing promotional price offers.

According to another characteristic, a marketing database contains data on each customer of the mobile telephony operator such as the type of contract binding the two parties for example.

A further purpose is to propose the giving of a secure access to these offers.

According to another characteristic, the application sub-system compares the SIM card IMSI number of the terminals connected to the network during polling with those contained in the marketing database, only the IMSI numbers collected during polling and which correspond to those of customers of the operator being stored in the memory of the support database.

According to another characteristic, the interactive vocal server has means enabling it to identify the user's caller number so as to compare this number with those stored in the promotonal database.

According to another characteristic, the interactive vocal server is accessible via a short number and has means enabling it to identify the user's caller number thereby restricting access upstream to only those customers of the operator making the promotional price offer.

According to another characteristic, the short access number to the interactive vocal server is zero rated (free call) so that prepayment customers are able to have the offer, the calculation of possible call time in relation to their credit on the one hand, and on the other hand to reduced charging subsequent to the promotion on the called number ensuring the non exceeding of the prepaid debited amount management system by the valuing system.

According to another characteristic, the vocal server distributes a dissuasive message in the case that the user's caller number is unknown to the promotional database.

According to another characteristic, the promotional database is connected to a pre-valuing system whose function is to issue promotional tickets intended to be used for invoicing the call.

According to another characteristic, at the time of the issue of the promotional ticket in digital form, the pre-valuing system uses data derived from the promotional database such as information on the promotion which the user have, the original cell from which the call is emitted, the time of the call, the duraction of the call, and the number called.

According to another characteristic, once the ticket is issued, it is transmitted by the pre-valuing system to the valuing system to be used when invoicing the customer.

According to another characteristic, each user of the mobile telephony network receives a personalized offer which takes into account the number of hours in the user's package, the user's subscribed services and customary consumption.

A further purpose is to propose a method for constructing, distributing and applying a network use offer that is scalable and time-limited for constructing, distributing and applying of at least one network offer, in particular of a mobile telephony network, characterized in that it comprises the following steps:
a launch step via the input interface of the application system to launch polling by the application sub-system in order to determine network load,
a polling step of the network by the sub-system,
a comparison step by the sub-system comparing information obtained during polling with the data contained in the application system and the marketing database,
a memorisation step by the application sub-system to store the SIM card IMSI number of the terminals affiliated to the operator and connected to the selected transmission stations,
a transmission step by the application system to transmit the information contained in the support database and in the offer database towards the promotional database which is linked to the interactive vocal server,
an information step informing the user of a mobile terminal whose SIM card IMSI number is stored in the support database, via SMS or WAP push,
a step during which the user calls a short number placing the user in contact with the interactive vocal server,
an issue step by the pre-valuing system of a promotional ticket needed for invoicing the communication made under the promotional price rate.
a transmission step of the promotional ticket towards the valuing system which manages the user's invoicing.

According to another characteristic, the interactive vocal server distributes a dissuasive message when contacted by a user whose IMSI number is not stored in the promotional database.

Other characteristics and advantages of the present invention will become more readily apparent on reading the following description given with reference to the appended drawings in which:

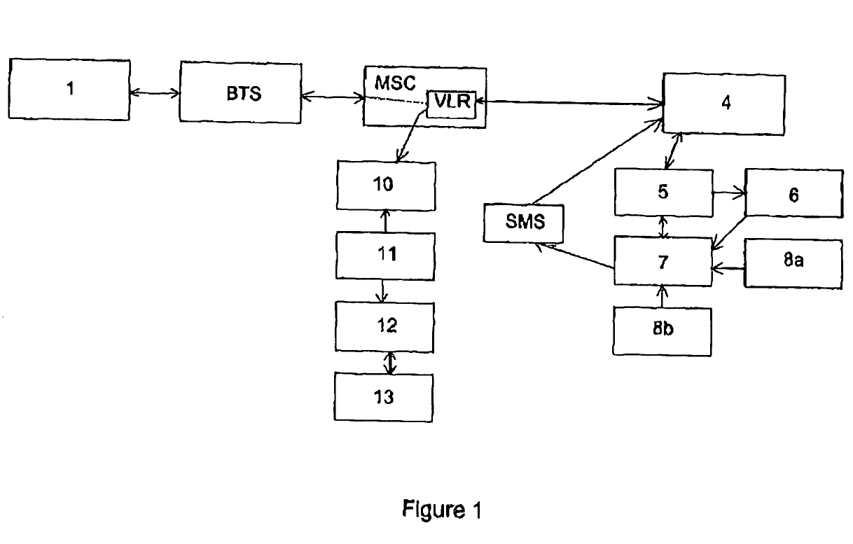

FIG. 1 is a flow-chart grouping together the different constituent parts of the system according to the invention and their interaction,

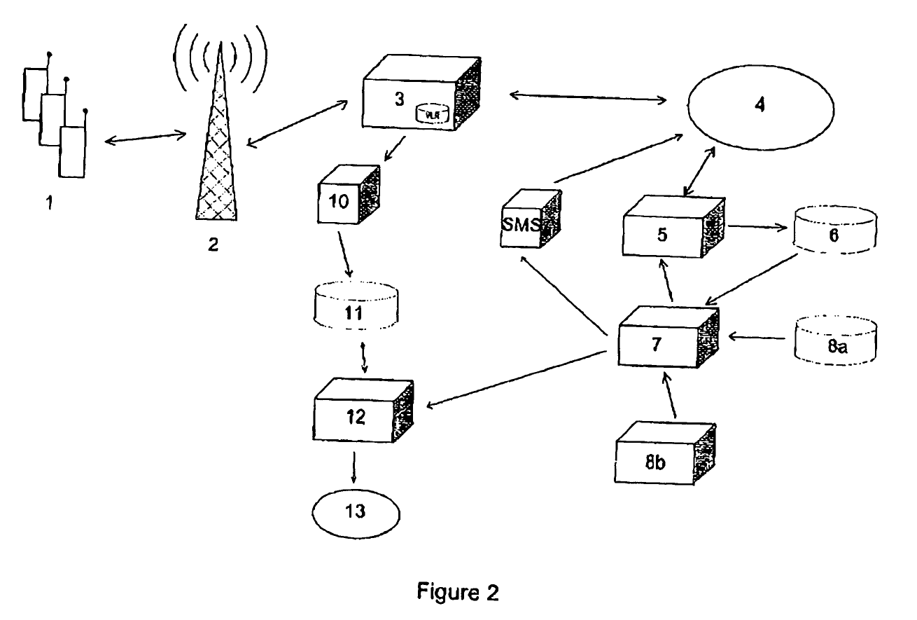

FIG. 2 is a schematic showing the interactions between the various components of the system according to the invention,

The invention concerns communication networks and more particularly mobile telephony networks.

A mobile telephony system uses a radio-electric link to enable communication between a terminal (1) and a communication network (4).

A mobile telephony network, of GSM type for example, consists of two sub-systems, a radio sub-system and a network sub-system.

The radio sub-system comprises a web of base stations (BCS) (2) which in particular manage allocations of call channels and command one or more transmission stations (BTS) (2). Transmission stations consist of equipment made up of radio receivers-transmitters and form an interface between the base stations (BSC) and mobile terminals (1).

The network sub-system essentially consists of fixed switching centres (MSC) (3) enabling management of incoming and outgoing calls, and databases of VLR type (Visitor Location Register). VLRs contain information on the geographical location of the user and data such as the user's IMSI identifier which are integrated in the MSC. The transmission stations (2), via radio-electric waves, transmit data on the mobile terminals (1) connected to them towards the base station (BSC) on which they depend. The base station (BSC), contains the position of the different transmission stations for which it ensures the management, in memory means, and stores the information received from the different transmission stations (2) which relates to the identifiers of mobile terminals (1) in other memory means. The base stations then transmit via radio or cable communication, the information contained in their various memory means towards the fixed switching centres MSC which store the same in memory means of the VLRs. The information contained in the VLRs is collected by the operator when polling the network via the polling channels of the network's physical layers. The information received is then classified by the network administration system in different databases to facilitate its management.

The user of a mobile telephony network moves over different points in the territory covered by the network. When moving, this user must be able to call or be called, hence the notion of <<roaming>>. When in communication, the mobile terminal (1) has a radio link with a determined base station (BCS). Each base station (BCS) manages several transmission stations (2) and the radio source. To ensure continuity of service when the user moves, it is sometimes necessary to change the base station with which the terminal is linked while maintaining the communication, this is the intercell transfer called <<handover>>. The base stations (BCS) decide a <<handover>> and inform the VLR of the change in geographical location of the mobile terminal so that its position may be known to network (4) at all times. A telephony network of GSM type proposes said follow-up system for communications.

The system of the invention is based on the principle of network load analysis and on customary communication habits of users. Correlation between these data items enables the mobile telephony operator to know which times and which locations lend themselves to a promotional offer for network use.

During an initial phase, one or more commercial representatives working for a mobile telephony operator launch a poll through the MSC of the transmission stations (2) forming the network (4) in order to determine their immediate load rate (number of allocated frequencies compared with the number of total frequencies) and their hosting rate [number of mobile terminals (1) under the influence of a given transmission station (2)]. This polling is made via an input and display interface of an application system (7). The application system (7) is linked to an application sub-system (5), a so-called “offer” database (8a) containing different types of offers and a system containing marketing information such as type of customer contract or location of customer terminal, etc . . . . The application sub-system (5) using messages polls the different transmission stations of the network and compares the information contained in the reply messages with previously defined parameters which it contains in memory means. The mobile terminals (1) communicating via the transmission stations selected by the application sub-system on the basis of sufficient conditions of use to warrant a promotional offer are stored in a so-called support database (6) containing their IMSI number and data on the applied promotional offer.

The application system (7) contains means for memorizing information on the different network parameters. These parameters concern the network transmission stations and the mobile terminals using these stations. The parameters on transmission stations contain the following information: the traffic load of stations, the fact that some stations are excluded from the promotional offer (“black listing”), <<handover>> and <<roaming>> rates. The parameters on mobile terminals are used to determine by comparison with identity data stored in the marketing database whether a terminal connected to a given transmission station is a terminal affiliated to the operator whose network it is using (in which case it may benefit from a promotional price offer if such exists); if this is not the case this terminal must be excluded from the promotional price offer possibly available to terminals connected to this transmission station and for this purpose any information related to this mobile terminal must be deleted from the network's databases.

The application system (7) transmits this data to the application sub-system (5) which stores this data in memory and takes it into account when polling the various transmission stations forming the mobile telephony network. The application sub-system will therefore act as an administration centre (OMC) supervising all the network transmission stations when polling these stations with the MSC via the remote polling channels of the network's physical layers or via probes.

Therefore, after polling the network by the application sub-system (5), only data on customers whose identity is stored in the marketing information system (8b) and whose connection to a transmission station is determined, will be stored in the support database (6) as customer of the operator.

Once the transmission stations (2) have been selected by the sub-systems, the users whose terminal (1) communicates via said stations and whose IMSI number has been stored in the support database (6) must be informed that they will be able to have a promotional network use offer and of the conditions under which they may have it.

The application system (7) via the support database collects the IMSI numbers of the terminals having the promotional offer and launches procedure for sending a message by SMS or WAP push to all these terminals.

WAP (Wireless Application Protocol) is a communication protocol intended to allow communication between a wireless terminal, having an URL address for its identification and optional contacting, and a service provider which also has an URL contact address. Through misuse of language WAP also designates an interactive data exchange service between a user having a mobile terminal and a multimedia service provider such as a mobile telephony operator. The data exchanged via WAP depend upon the service contacted by the user and may for example concern weather forecasts, cinema times, or even road traffic conditions.

WAP push technology, for amobile telephony operator, consists of forcing a mobile terminal (1) to connect to its server via WAP, i.e. it is not the user of the mobile terminal who decides to connect to the operator's server via the WAP, but the user's operator which makes this connection automatically for service needs. When the operator wishes to set up a forced connection, several parameters must be given consideration. Initially the operator must verify that the user is a subscriber to the multimedia services and that according to the IMEI number sent by the telephone the user has a terminal able to receive a message via WAP; simple verification of the customer account in the marketing database (8b) informs the application system (7) of this status. Secondly, the operator must verify that the user is connected to a station of the network through automatic callback procedure. If the user is connected to the network, the application system (7) having determined the URL address of the user's terminal (1), triggers the sending of a message using WAP. If not, the automatic callback verifies the user's connection status until the user connects to the network.

The application system (7) also sends information to a so-called “promotional” database (11) on the promotion in progress and various data on the terminals which may have this promotion, such as their caller number or IMSI number.

The information message sent via SMS or WAP push indicates the having of a promotional offer to the terminal's owner and the procedure to be followed to use this offer. By way of example the offer may be a 50% reduction for any call made after a certain hour. The owner of the mobile terminal (1) calls a free short number indicated in the SMS or message sent by WAP push, the non-charging of this call enabling users of the prepaid system to have the offer. This call arrives at an interactive vocal server called <<Promotion Reception Front>> (10). This system has means to identify the caller's number (benefiting from the promotional rate). Once the caller number has been identified, the interactive vocal server (10) uses routine comparison procedure to compare this number with those contained in the promotional database. If the caller number is not stored in the promotional database (11), the interactive vocal server (10) gives a dissuasive message indicating that the user is unable to have the promotional price offer even though informed thereof.

If the promotional database (11) contains the user's caller number this means that the user has an account in the operator's database. The user is then invited to dial the number of the person he wishes to call.

A pre-valuing system (12) issues the data of a promotional ticket which will be used to “invoice” the user. To issue this promotional ticket the pre-valuing system (12) uses information derived from the user account contained in the promotional database (11), such as information on the promotion which the user can have, information on the cell from which the call originates, the time of the call, its duration, the number called, etc . . . . The pre-valuing system also uses data on the user contained in the valuing system (13). This information concerns the users price conditions (package, prepaid account) the cost of the user's communications per minute, etc . . . . Once the data of this promotional ticket is determined, it is transmitted by the pre-charging system (12) to the charging system which manages the invoicing of the user (or decrementing of a prepaid account when applicable) taking into consideration that for some calls the user has benefited from promotional rates. The charging system (13) is provided with routines with which to calculate the call time available to a user with a prepaid account, on the basis of remaining credit and reduced charging subsequent to the promotion. This information ensures that the amount deducted from the account management system by the charging system (13) does not exceed the prepaid amount.

The system of the invention offers operators of mobile telephony the opportunity to adapt their promotional offers with great flexibility in relation to the activity rate of their network and data on their customers. This flexibility is due to several factors.

One first factor derives from the fact that the system offers cell-by-cell network polling which allows offers that are highly localized in space.

A second factor derives from the fact that this polling is launched at a precise time chosen by the operator. This provides an offer that is localized in time.

A third factor derives from the fact that the proposed offers are personalized in relation to customer data contained in the various databases forming the system of the invention. Each customer concerned by the promotional receives a personalized offer which takes into account the contract (number of hours contained in customer's package, services subscribed to, etc . . . ) and usual calling habits (time slots when package is used, average duration of calls, etc . . . ).

The two first factors enable mobile telephony operators to make their networks more efficient by distributing the communications of its customers homogeneously in time and space. The third factor enables mobile telephony operators to propose personalized offers to customers, meeting their needs and calling habits.

It will be obvious to persons skilled in the art that the present invention allows other embodiments in numerous other specific forms without departing from the area of application of the invention as claimed. Therefore the above-described embodiments are to be considered as illustrations which can undergo modifications within the sphere specified by the scope of the appended claims and the invention is not to be restricted to the details given above.

1. System for constructing, distributing and applying at least one promotional offer for network use, in particular of mobile telephony networks, comprising at least one transmission station (2) to which is connected at least one mobile terminal (1), an interactive vocal service (10), several databases (11, 8a, 8b, 6) containing information on clientele or network status, characterized in that an application sub-system (5) actuated via the input interface of an application system (7) polls the transmission stations (2) forming a mobile telephony network (4) in order to know the occupancy rate of the network (4) and the SIM card IMSI number of mobile terminals (1) connected to the network, these results are stored in a support database (6) and compared with data contained in the other databases (11, 8a, 8b) by the application system (7) which, in relation to criteria, determines the users to be selected and subsequently invites the selected mobile terminal users to contact the interactive vocal service (10) to benefit from a personalized promotional price offer.

2. System for constructing, distributing and applying at least one promotional price offer as in claim 1, characterized in that the application sub-system (5) polls the transmission stations (2) via remote polling channels of the network's physical layers or via probes.

3. System for constructing, distributing and applying at least one promotional price offer as in claim 1, characterized in that the polling of the transmission stations (2) can determine their immediate load rate and hosting rate.

4. System for constructing, distributing and applying at least one promotional price offer as in claim 1, characterized in that the parameters related to the transmission stations (2) and contained in the application system represent the service load of the stations, the exclusion of some stations from the promotional offer, the <<handover>> rate and the <<roaming>> rate.

5. System for constructing, distributing and applying at least one promotional price offer as in claim 1, characterized in that the invitation given to the user to contact the interactive vocal service is made via SMA or WAP push.

6. System for constructing, distributing and applying at least one promotional price offer as in claim 1, characterized in that the support database (6) contains information derived from polling of the network (4) made by the application sub-system (5) and the SIM card IMSI number of the terminals connected to the network at the time of polling.

7. System for constructing, distributing and applying at least one promotional price offer as in claim 1, characterized in that the offer database (8a) contains information on the different types of existing promotional price offers.

8. System for constructing, distributing and applying at least one promotional price offer as in claim 1, characterized in that the marketing database (8b) contains information on each customer of the mobile telephony operator such as the type of contract for example binding the two parties.

9. System for constructing, distributing and applying at least one promotional price offer as in claim 1, characterized in that the application sub-system (5) compares the SIM card IMSI numbers of the terminals (1) connected to the network during polling with those contained in the marketing database (8b), only those IMSI numbers collected during polling and which correspond to those of customers of the operator being stored in the support database (6).

10. System for constructing, distributing and applying at least one promotional price offer as in claim 1, characterized in that the interactive vocal server (10) has means enabling it to identify the user's caller number in order to proceed with comparison between this number and those stored in the promotional database (11).

11. System for constructing, distributing and applying at least one promotional price offer as in claim 10, characterized in that the interactive vocal server (10) is accessible via a short number and has means to recognize the user's caller number, thereby providing upstream limiting of access to only those customers of the operator making the promotional price offer.

12. System for constructing, distributing and applying at least one promotional price offer as in claim 11, characterized in that the short access number to the interactive vocal server (10) is zero rated (free call), thereby enabling prepayment customers to benefit from the offer, the calculation of possible call time in relation to their credit and to reduced charging subsequent to the promotion on the called number ensuring that the amount deducted from the account management system by the charging system (13) does not exceed the prepaid amount.

13. System for constructing, distributing and applying at least one promotional price offer as in claim 10, characterized in that the interactive vocal server (10) disseminates a dissuasion message in the event that the user's caller number is unknown to the promotional database (11).

14. System for constructing, distributing and applying at least one promotional price offer as in claim 1, characterized in that the promotional database (11) is connected to a pre-charging system (12) whose function is to emit promotional tickets intended to be used for invoicing the communication.

15. System for constructing, distributing and applying at least one promotional price offer as in claim 14, characterized in that the pre-charging system, when emitting the promotional ticket in digital form, uses information derived from the promotional database (11) such as information on the promotion benefiting the user, the originating cell of the call, the duration of the call, the number called.

16. System for constructing, distributing and applying at least one promotional price offer as in claim 10, characterized in that once the ticket is emitted, it is transmitted by the pre-charging system (12) to the charging system (13) which takes it into account when invoicing the user.

17. System for constructing, distributing and applying at least one promotional price offer as in claim 1, characterized in that each user of the mobile telephony network (4) receives a personalized offer which takes into consideration the number of hours in the user's package, the services subscribed to and customary calling habits.

18. Method for constructing, distributing and applying at least one promotional offer for use of a network, in particular a mobile telephony network, which can be used in a system as in claim 1, characterized in that it comprises the following steps:
a launch step via the input interface of the application system (7) to launch polling of the network (4) by the application sub-system (5) in order to determine the traffic load of the network (4),
a polling step of the network (4) by the sub-system (5),
a comparison step by the sub-system (5), comparing information obtained during polling with the data contained in the application system (7) and the marketing database (8b),
a memorization step by the application sub-system (5) memorizing the SIM card IMSI number of the terminals affiliated to the operator and connected to the selected transmission stations,
a transmission step by the application system (7) transmitting information contained in the support database (6) and offer database (8a) to the promotional database (11) linked to the interactive vocal server (10),
an information step informing a mobile terminal (1) user whose SIM card IMSI number is stored in the support database (6), via SMS or WAP push,
a step during which the user calls a short number to contact the interactive vocal server (10),
an emission step by the pre-charging system (12) of a promotional ticket needed for invoicing the communication made under the promotional price offer,
a transmission step of the promotional ticket to the charging system (13) which manages user invoicing.

19. Method for constructing, distributing and applying at least one promotional price offer as in claim 16, characterized in that the interactive vocal server (10) emits a dissuasive message when contacted by a user whose IMSI number is not stored in the promotional database (11).
